(19) United States
(12) Patent Application Publication
(10) Pub. No.: US 2014/0214555 A1
(43) Pub. Date: Jul. 31, 2014

(54) EXTERNALITIES IN AN AUCTION

(71) Applicant: Google Inc., Mountain View, CA (US)

(72) Inventors: Jonathan E. Feldman, New York, NY (US); Jeremy L. Whelchel, New York, NY (US); Varun Sharma, Baltimore, MD (US)

(73) Assignee: Google Inc., Mountain View, CA (US)

(21) Appl. No.: 13/753,865

(22) Filed: Jan. 30, 2013

(51) Int. Cl. G06Q 30/02

(52) U.S. Cl. CPC G06Q 30/0275
USPC 705/14.71

(57) ABSTRACT

Methods, systems, and apparatus, including computer programs encoded on a computer-readable storage medium, for reporting an externality effect. A method includes: identifying an auction associated with a content item request, the auction including one or more eligible inventory items for presentation responsive to the content item request and including a first inventory item associated with a first entity; evaluating results of the auction including determining an externality effect of another eligible inventory item in the auction on the first inventory item; and reporting the externality effect.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for reporting an externality effect. The method comprises: identifying an auction associated with a content item request, the auction including one or more eligible inventory items for presentation responsive to the content item request and including a first inventory item associated with a first entity; evaluating results of the auction including determining an externality effect of another eligible inventory item in the auction on the first inventory item; and reporting the externality effect.

In general, another aspect of the subject matter described in this specification can be implemented in computer program products. A computer program product tangibly embodied in a computer-readable storage device comprises instructions that, when executed by a processor, cause the processor to: identify an auction associated with a content item request, the auction including one or more eligible inventory items for presentation responsive to the content item request and including a first inventory item associated with a first entity; evaluate results of the auction including determining an externality effect of another eligible inventory item in the auction on the first inventory item; and report the externality effect.

In general, another aspect of the subject matter described in this specification can be implemented in systems. A system comprises a content management system and an auction simulator. The auction simulator is configured to identify an auction associated with a content item request received by the content management system, the auction including one or more eligible inventory items for presentation responsive to the content item request and including a first inventory item associated with a first entity. The content management system is configured to: evaluate results of the auction including determining an externality effect of another eligible inventory item in the auction on the first inventory item; and report the externality effect.

These and other implementations can each optionally include one or more of the following features. Determining the externality effect can include determining an effect on the first inventory item of removing the another eligible inventory item from the auction. Determining the externality effect can include simulating the performance of the auction with the another eligible inventory item removed from the auction. Determining the externality effect can include determining one or more of a change in cost to the first entity, a change in position of the first inventory item on a resource associated with the request, a change in predicted interaction rate for the first inventory item, or a change in a predicted conversion rate for the first inventory item. A second externality effect can be determined wherein the second externality effect is a measure of an effect of the first inventory item on the another eligible inventory item in the auction. The second externality effect can be reported. A plurality of additional auctions in which the first inventory item and the another eligible inventory item participated can be identified. Results of the plurality of auctions can be evaluated including determining for each auction an externality effect of the another eligible inventory item in the auction on the first inventory item, aggregating the determined externality effects for each auction, and reporting the aggregate externality effect. The plurality of auctions can be in a same dimension as the auction and aggregating the externality effect can include aggregating an effect over the dimension. The dimension can define a grouping including a grouping defined by a time period, a location, a demographic criterion, a requesting source, or other grouping. A request for content can be received. A ranking for the first inventory item and the another eligible inventory item can be determined in the auction and presentation of a content item can be enabled responsive to the request based at least in part on the determined ranking. A suggestion can be provided to the first entity for adjusting a campaign associated with the first inventory item. One or more additional auctions can be determined in which the first inventory item competed against either the another inventory item or other inventory items associated with a same domain. An externality can be determined for each additional auction. The determined externality data can be aggregated for the additional auctions. An aggregate externality effect can be reported based on the aggregating, wherein the aggregated externality effect is a measure of an effect of inventory items from the domain on the first inventory item.

Particular implementations may realize none, one or more of the following advantages. A first content sponsor can be provided with information that indicates one or more effects on the first content sponsor from a second content sponsor. A first content provider can be provided with information that indicates the effect of the first content provider on a second content provider.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content to a user.

FIG. 2 illustrates example web pages.

FIG. 3 is a flowchart of an example process for reporting an externality effect.

FIGS. 4A, 4B and 6 are flowchart of example processes for reporting an aggregate externality effect.

FIG. 5 illustrates an example externality report.

FIG. 7 is a block diagram of computing devices that may be used to implement the systems and methods described in this document, as either a client or as a server or plurality of servers.

Like reference numbers and designations in the various drawings indicate like elements.

### DETAILED DESCRIPTION

An auction associated with a content item request can be identified. The auction can include, for example, a set of eligible inventory items for presentation responsive to the content item request. Results of the auction can be evaluated including determining an externality effect of a first eligible inventory item in the auction on a second eligible inventory item. For example, the following effects can be determined by removing the first inventory item from the auction: a change in cost to a sponsor of the second inventory item, a change in position of the second inventory item on a resource associated with the content item request, a change in predicted interaction rate for the second inventory item, or a change in a predicted conversion rate for the second inventory item. The determined externality effect(s) can be reported, such as to the sponsor of the second inventory item.

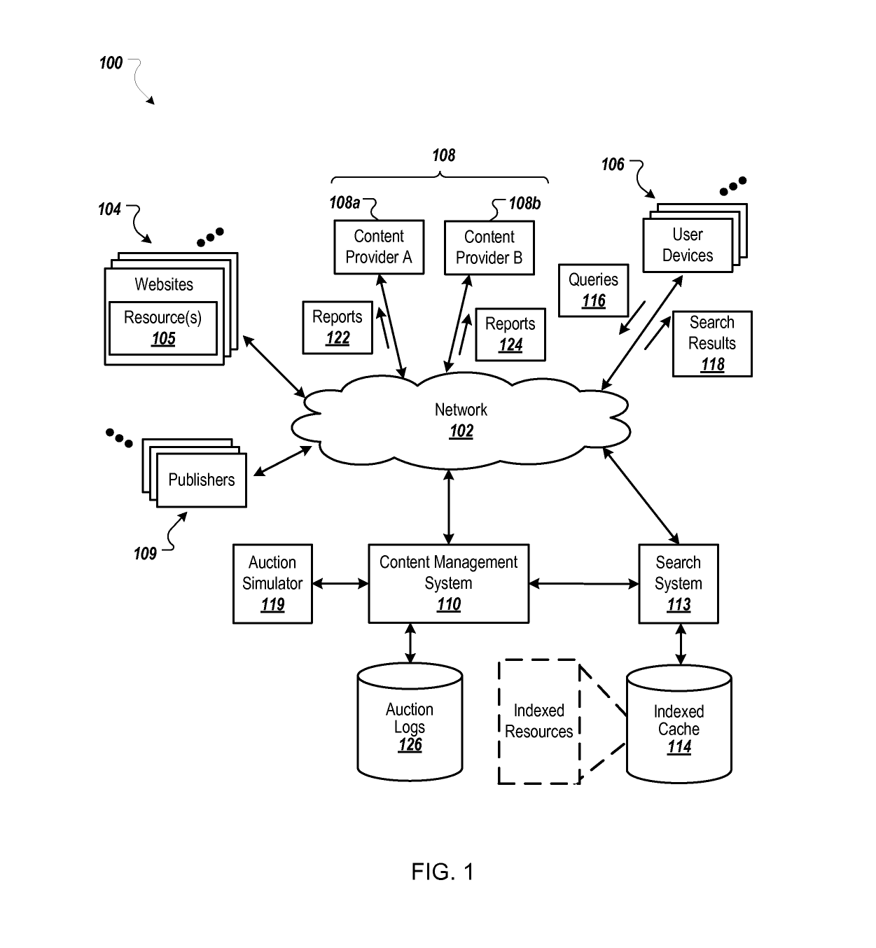

FIG. 1 is a block diagram of an example environment 100 for providing content to a user. The example environment 100 includes a network 102 such as a local area network (LAN), wide area network (WAN), the Internet, or a combination thereof. The network 102 connects websites 104, user devices 106, content providers 108 (e.g., a content provider 108a and a content provider 108b), publishers 109, and a content management system 110. The example environment 100 may include many thousands of websites 104, user devices 106, content providers 108, and publishers 109.

A website 104 includes one or more resources 105 associated with a domain name and hosted by one or more servers. An example website 104 is a collection of webpages formatted in hypertext markup language (HTML) that can contain text, images, multimedia content, and programming elements, e.g., scripts. Each website 104 is maintained by, for example, a publisher 109, e.g., an entity that controls, manages and/or owns the website 104.

A resource 105 is any data that can be provided over the network 102. A resource 105 is identified by a resource address that is associated with the resource 105. Resources 105 include HTML pages, word processing documents, and portable document format (PDF) documents, images, video, and feed sources, to name only a few examples. The resources 105 can include content, e.g., words, phrases, images and sounds that may include embedded information (such as meta-information in hyperlinks) and/or embedded instructions (such as JavaScript scripts).

To facilitate searching of resources 105, the environment 100 can include a search system 112 that identifies the resources 105 by crawling and indexing the resources 105 provided by the publishers 109 on the websites 104. Data about the resources 105 can be indexed based on the resource 105 to which the data corresponds. The indexed and, optionally, cached copies of the resources 105 can be stored in an indexed cache 114.

A user device 106 is an electronic device that is under control of a user and is capable of requesting and receiving resources 105 over the network 102. Example user devices 106 include personal computers, mobile communication devices, tablet devices, and other devices that can send and receive data over the network 102. A user device 106 typically includes a user application, such as a web browser, to facilitate the sending and receiving of data over the network 102 and the presentation of content to a user.

A user device 106 can request resources 105 from a website 104. In turn, data representing the resource 105 can be provided to the user device 106 for presentation by the user device 106. User devices 106 can also submit search queries 116 to the search system 112 over the network 102. In response to a search query 116, the search system 112 can access the indexed cache 114 to identify resources 105 that are relevant to the search query 116. The search system 112 identifies the resources 105 in the form of search results 118 and returns the search results 118 to the user devices 106 in search results pages. A search result 118 is data generated by the search system 112 that identifies a resource 105 that is responsive to a particular search query 116, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource (“resource keywords”) or a search query 116 for which search results 118 are requested can also be provided to the content management system 110 to facilitate identification of content that is relevant to the resource or search query 116. A request for a resource 105 or a search query 116 can also include an identifier, such as a cookie, identifying the requesting user device 106 (e.g., in instances in which the user consents in advance to the use of such an identifier).

Based, for example, on data included in the request for content, the content management system 110 can select content items that are eligible to be provided in response to the request, such as content items having characteristics matching the characteristics of a given slot. As another example, content items having selection keywords that match the resource keywords or the search query 116 may be selected as eligible content items by the content management system 110. One or more selected content items can be provided to the user device 106 in association with providing an associated resource 105 or search results 118.

In some implementations, the content management system 110 can select content items based at least in part on results of an auction. In some implementations, some content providers 108 prefer that the number of impressions allocated to their content and the price paid for the number of impressions be more predictable than the predictability provided by an auction. For example, a content provider 108 can increase the likelihood that its content receives a desired or specified number of impressions, for example, by entering into an agreement with a publisher 109, where the agreement requires the publisher 109 to provide at least a threshold number of impressions (e.g., 1,000 impressions) for a particular content item provided by the content provider 108 over a specified period (e.g., one week). In turn, the content provider 108, publisher 109, or both parties can provide data to the content management system 110 that enables the content management system 110 to facilitate satisfaction of the agreement.

For example, the content provider 108 can upload a content item and authorize the content management system 110 to provide the content item in response to requests for content corresponding to the website 104 of the publisher 109. Similarly, the publisher 109 can provide the content management system 110 with data representing the specified time period as well as the threshold number of impressions that the publisher 109 has agreed to allocate to the content item over the specified time period. Over time, the content management system 110 can select content items based at least in part on a goal of allocating at least a minimum number of impressions to a content item in order to satisfy a delivery goal for the content item during a specified period of time.

In implementations where the content management system 110 selects content items based at least in part on results of an auction, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). When multiple slots are allocated in a single auction, the slots can be allocated to a set of bidders that provided the highest bids or have the highest auction scores.

Content providers 108 can be in competition with each other, such as for winning a slot in an auction. A particular content provider 108 (e.g., the content provider 108a) may desire, for example, to know an economic effect that another content provider 108 (e.g., the content provider 108b) has on the particular content provider 108. As another example, the content provider 108a may desire to know an economic effect that the content provider 108a has on the content provider 108b. As another example, an administrator of the content management system 110 may desire to know the effects of various content providers 108 on other content providers 108.

An effect of one content provider 108 on another content provider 108 can be referred to an externality effect. In some implementations, an externality effect of the content provider 108a on the content provider 108b for a given auction can be determined by simulating the execution of the auction as if the content provider 108a were not participating in the auction. For example, the content management system 110 can use an auction simulator 119. An externality effect on the content provider 108b can be determined by determining an effect on the content provider 108b of removing one or more content items provided by the content provider 108a from the auction simulation.

Externality effects can be reported, for example, to content providers 108. For example, an externality report 122 can be provided to the content provider 108a which indicates an externality effect of the content provider 108b on the content provider 108a. Similarly, an externality report 124 can be provided to the content provider 108b which indicates an externality effect of the content provider 108a on the content provider 108b. The externality effects included in the reports 122 and 124 can include, for example, information related to changes in cost to a respective content provider, changes in location (e.g., higher position, different content block) of content items on resources associated with requests for content, changes in predicted interaction rates for content items, or changes in predicted conversion rates for content items. Other effect data is possible.

In some implementations, the reports 122 and 124 include information aggregated over multiple auctions. For example, the content management system 110 can identify (e.g., from auction logs 126) one or more auctions in which one or more content items provided by the content provider 108a and one or more content items provided by the content provider 108b participated. The content management 110 can, for each identified auction, simulate the auction using the auction simulator 119 with content items associated with the content provider 108a removed. The content management system 110 can evaluate results of the one or more simulated auctions including determining, for example, for each auction, an externality effect of the content provider 108a on the content provider 108b. The content management system 110 can aggregate the determined externality effects for each auction and can report an aggregate externality effect, such as in the report 122 and/or the report 124.

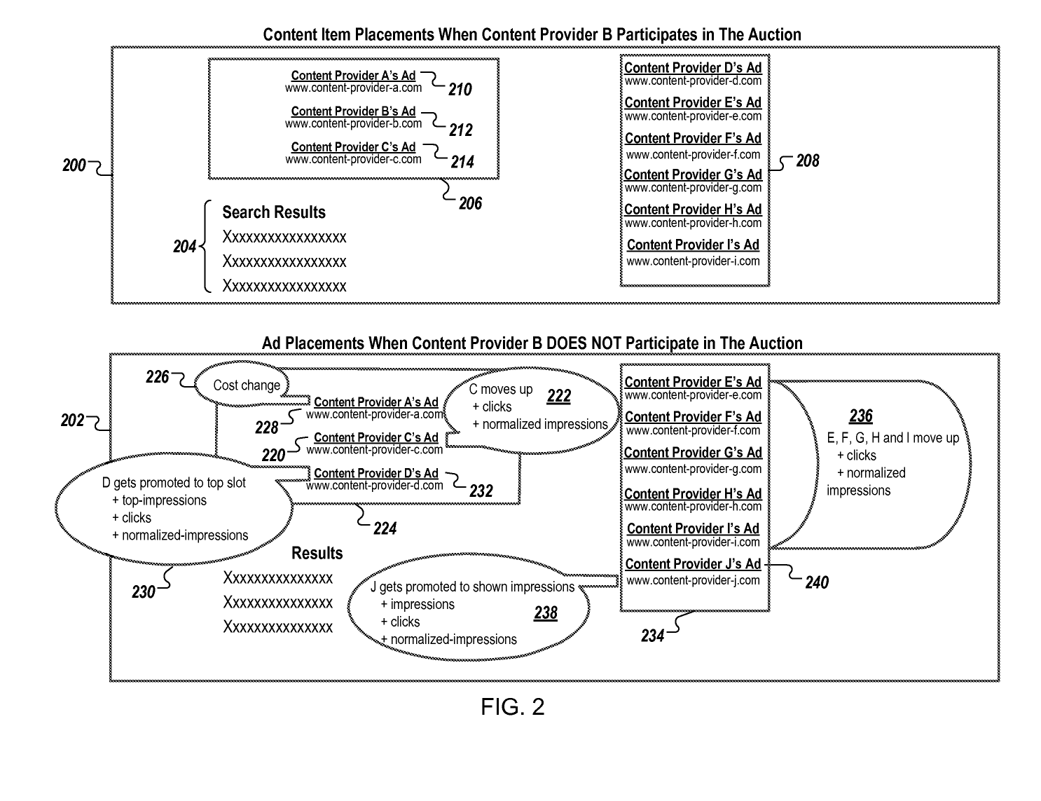

FIG. 2 illustrates example web pages 200 and 202. The web page 200 includes search results 204, a top content block 206, and a side content block 208. A request for content can be sent to a content management system for content to be presented in the top content block 206 and the side content block 208. The content management system can, for example, conduct an auction to determine content items (e.g., advertisements) to provide in response to the request. For example, content items 210, 212, and 214 associated with content providers A, B, and C, respectively, are presented in respective slots of the top content block 206. As another example, content items associated with content providers D, E, F, G, H, and I are presented in respective content slots of the side content block 208. When performing the auction, the content management system can rank content items and content items can be provided for the top content block 206 and the side content block 208, with the highest ranking content item being identified for the top slot in the top content block 206, the second and third highest ranking content items being identified for the second-highest and third-highest slots in the top content block 206, respectively, the fourth highest ranking content item identified for the top slot in the side content block 208, etc. Other arrangements are possible, such as those that do not necessarily provide the exact ranked order in a given block (e.g., the top block gets ranked items 1, 2 and 5 while the side block gets ranked items 3, 4, 6).

The content management system can evaluate results of the auction to determine an externality effect of a content item on other content items that were evaluated during the auction. Determining an externality effect can include, for example, determining an effect on a first content item of removing a second content item from the auction. Effects can include, for example, a change in cost to the content provider of the first content item, a change in position of the first content item on a resource associated with the content request, a change in a predicted interaction rate for the first content item, or a change in a predicted conversion rate for the first content item. Other effects can be measured. The content management system can determine externality effects of an auction by simulating the auction as if content items associated with a particular content provider had not participated in the auction.

The web page 202, for example, illustrates effects on the auction corresponding to the content request associated with the web page 200 that may have occurred if the content provider B had not participated in the auction. In the auction corresponding to the content request associated with the web page 200, the content item 212 associated with the content provider C received a second-highest ranking. As illustrated by a content item 220 associated with the content provider C and by a note 222, with the content provider B not in the auction, the content provider C can provide the content item 220 for the second highest slot in a top content block 224 (where the top content block 224 corresponds to the top content block 206).

As indicated by the note 222, the content item 220 may receive a higher number of interactions (e.g., clicks) and a higher number of “normalized impressions”. In some implementations, normalized impressions refer to a metric which represents a likelihood that a user sees a content item, where the likelihood is based on the placement of the content item. For example, a likelihood of a content item in the top slot of the top block being seen may be 90%, the likelihood of a content item in the second-highest slot of the top block may be 80%, etc. Since the content item for the content provider C had been in the third highest slot in the top content block 206 and may now be in the second highest slot in the top content block 224, the normalized impressions for the content item 220 may increase.

As indicated by a note 226, the content provider A may incur a change in cost for having a content item 228 (e.g., corresponding to the content item 210) remaining in a top slot (e.g., of the top content block 224). For example, with the content provider B not participating in the auction, final bid amounts can change for the content provider A and for other content providers. As indicated by a note 230, a content item 232 associated with the content provider D can appear in (e.g., be promoted to) the top content block 224 from a side content block 234 (e.g., the side content block 234 corresponding to the side content block 208). The note 230 indicates that the content item 232 may receive increased interactions (e.g., clicks), increased normalized impressions, and increased “top impressions” (where top impressions is a metric which indicates a placement in a top content block).

As indicated by a note 236, the content providers E, F, G, H, and I can have respective content items moved up one position in the side content block 234, which can result in increased interactions (e.g., clicks) and increased normalized impressions. Note 238 indicates that a content item 240 associated with a content provider J can be promoted from not being provided in the response to the content request to having a “shown impression” on the web page 202 in the bottom slot of the side content block 234. Accordingly, the content item 240 may receive increased impressions, interactions (e.g., clicks), and normalized impressions.

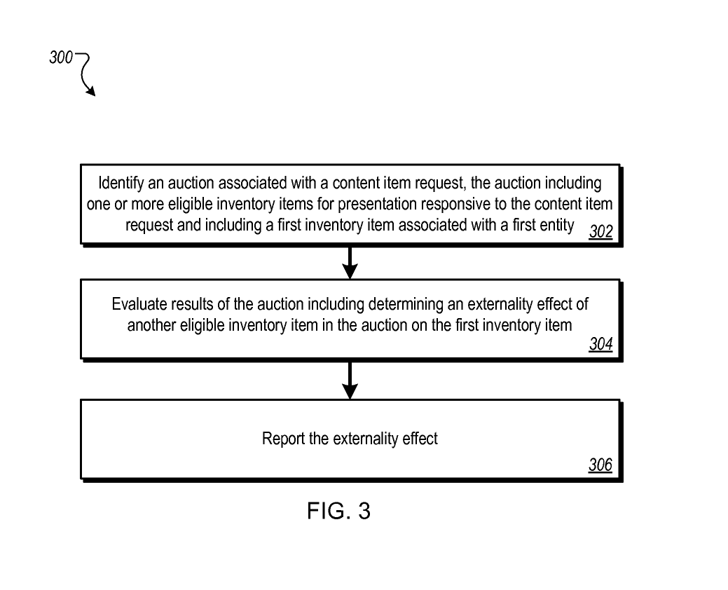

FIG. 3 is a flowchart of an example process 300 for reporting an externality effect. The process 300 can be performed, for example, by the content management system 110 described above with respect to FIG. 1.

An auction associated with a content item request is identified (302), where the auction includes one or more eligible inventory items for presentation responsive to the content item request and includes a first inventory item associated with a first entity. The auction can be identified, for example, from an auction logs repository.

Results of the auction are evaluated (304), including determining an externality effect of another eligible inventory item in the auction on the first inventory item. The another eligible inventory item can be associated, for example, with a second entity. Determining an externality effect can include determining an effect on the first inventory item of removing the another eligible inventory item from the auction. For example, determining the externality effect can include simulating the performance of the auction with the another eligible inventory item removed from the auction. An externality effect can relate to one or more of a change in cost to the first entity, a change in position of the first inventory item on a resource associated with the request, a change in predicted interaction rate for the first inventory item, or a change in a predicted conversion rate for the first inventory item, to name a few examples. In some implementations, a second externality effect is determined wherein the second externality effect is a measure of an effect of the first inventory item on the another eligible inventory item in the auction.

The externality effect is reported (306). For example, the externality effect can be reported to the first entity and/or the second entity. In implementations where the second externality effect is determined, the second externality effect can be reported to the first entity and/or the second entity. In some implementations, the first and/or the second externality effects are reported to an administrator of a content management system which performed the auction.

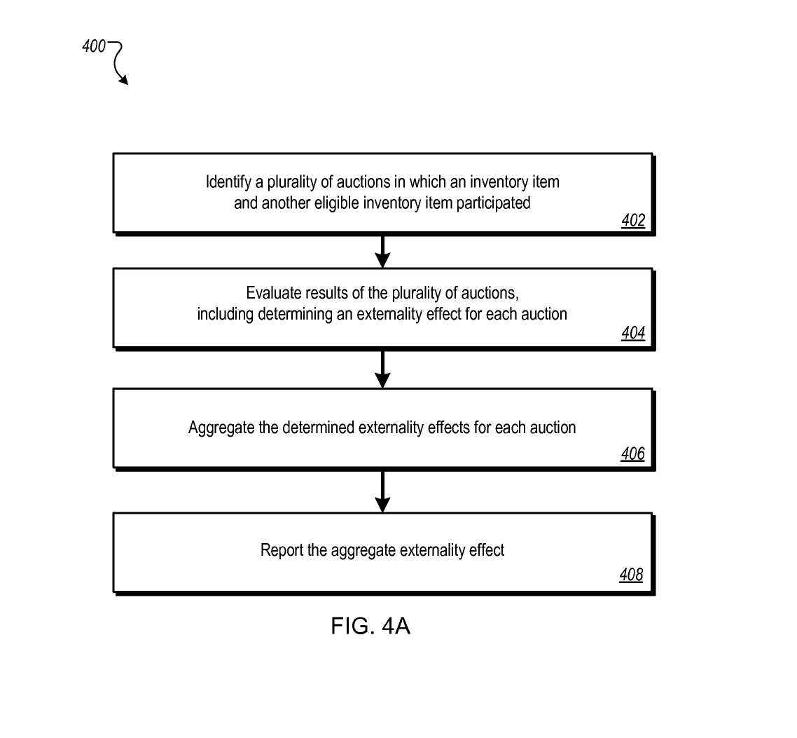

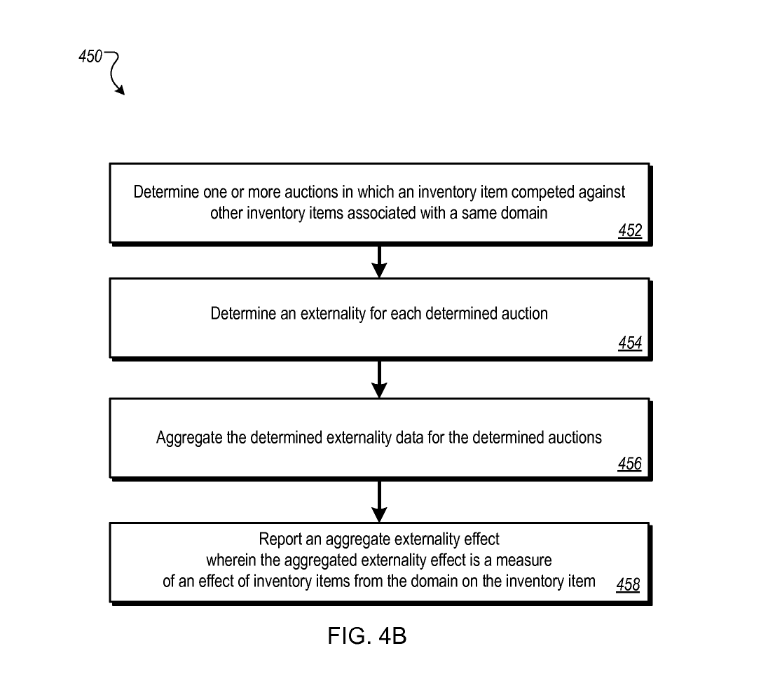

FIG. 4A is a flowchart of an example process 400 for reporting an aggregate externality effect. The process 400 can be performed, for example, by the content management system 110 described above with respect to FIG. 1.

A plurality of auctions in which an inventory item and another eligible inventory item participated is identified (402). The inventory item can be associated, for example, with a first entity and the other eligible inventory item can be associated with a second entity. The plurality of auctions can be identified, for example, from auction logs. Auctions which are associated with one or more dimensions can be identified, such as auctions occurring during a particular time period, in association with a user located at a particular location or set of locations, associated with particular types of users, or associated with requests from a particular requesting resource.

Results of the plurality of auctions are evaluated (404), including determining for each auction an externality effect of the another eligible inventory item in the auction on the inventory item. For example, an auction simulator can be used to simulate the plurality of auctions. The auction simulator can perform a first simulation for each identified auction to generate a set of base metrics. The auction simulator can perform a second simulation for each identified auction which simulates the respective identified auction with the other inventory item removed from the auction. A set of change metrics can be determined from the set of second simulated auctions. A difference between the change metrics and the base metrics can be determined for each auction. In some implementations, an interaction simulator can be used to estimate probabilities of interactions with content items given presentation and placement of the content items based on the first and second simulations.

For example, one or more of the following can be determined for the first entity for each auction: a change in cost to the first entity, a change in position of the inventory item on a resource associated with the request, a change in predicted interaction rate for the inventory item, or a change in a predicted conversion rate for the inventory item. A change in position can be the inventory item being in a different slot (e.g., higher or lower) in a content block, being in a different content block (e.g., moving from a top content block to a side content block or from a side content block to a top content block), appearing in a content block in the second simulated auction after not being presented in the first simulated auction, or not being selected for presentation after the second simulated auction after being selected for presentation after the first simulated auction.

The determined externality effects are aggregated over the auctions (406). For example, the following aggregated metrics can be determined for the inventory item: total cost, average cost, total impressions, total selections (e.g., clicks), total top impressions, and total normalized impressions.

The aggregate externality effect is reported (408). For example, the aggregate externality effect can be reported to the first entity and/or to an administrator of a content management system which performed the auctions.

FIG. 4B is a flowchart of an example process 450 for reporting an aggregate externality effect. The process 450 can be performed, for example, by the content management system 110 described above with respect to FIG. 1.

One or more auctions in which an inventory item competed against other inventory items associated with a same domain are determined (452). For example, the inventory item can be associated with a first domain and the other inventory items can be associated with a second domain. The first domain and the second domain can be domain names associated with a Domain Name Service (DNS). For example, the first domain can be “examplefirstdomain.com” and can be associated with a first entity and the second domain can be “exampleseconddomain.com” and can be associated with a second entity. Auctions which are associated with one or more dimensions can be identified, such as auctions occurring during a particular time period, in association with a user located at a particular location or set of locations, associated with particular types of users, or associated with requests from a particular requesting resource. The one or more auctions can be identified, for example, from auction logs.

In some implementations, auctions are determined in which any inventory item associated with the first domain competed against any inventory item associated with the second domain (e.g., to determine an externality effect of the second domain on the first domain and/or of the first domain on the second domain). In some implementations, auctions are determined in which any inventory item associated with the first domain competed against any inventory item associated with any other domain (e.g., to determine an externality effect of the first domain on other domain(s) and/or of other domain(s) on the first domain). Other examples are possible, such as determining auctions in which any inventory item associated with a particular campaign or other inventory item group competed with another set of inventory items (e.g., inventory items associated with the second domain).

An externality is determined for each determined auction (or all of the auctions in the aggregate) (454). An externality effect can relate to one or more of a change in cost to an entity associated with an inventory item, a change in position of an inventory item on a resource associated with the request, a change in predicted interaction rate for an inventory item, or a change in a predicted conversion rate for an inventory item, to name a few examples.

As required, the determined externality data is aggregated for the determined auctions (456). For example, an average change in cost per inventory item for an item, a total change in cost to the entity, an average change in predicted interaction rate, a total predicted change in interactions, an average change in predicted conversion rate, and a total predicted change in conversions can be determined. In implementations where auctions are determined in which any inventory item associated with the first domain competed against any inventory item associated with the second domain, the aggregate externality effect can be a measure of an effect of inventory items from the second domain on inventory items from the first domain.

In some implementations, aggregated metrics such as top inbound and top outbound externalities by interactions, cost, and top impressions can be determined for the first entity. Each of these metrics can include an ordered list of N entities that affect the first entity (e.g., for inbound metrics) or that are affected by the first entity (e.g., for outbound metrics). N can be a positive integer (e.g., 100) and can be the same or different for different aggregated metrics.

In further detail, a top inbound externalities by interactions metric can include an ordered list of top N entities who most affect expected interactions for the first entity. A top outbound externalities by interactions metric can include an ordered list of top N entities whose expected interactions are most affected by the first entity. Such externalities by interactions metrics can be based on positioned predicted interaction rates which are determined based on a predicted position (e.g., top slot, in top content block, in side content block) of an inventory item.

A top inbound externalities by cost metric can include an ordered list of the top N entities who most affect expected cost for the first entity. A top outbound externalities by cost metric can include an ordered list of the top N entities whose expected cost is most influenced by the first entity. A top inbound externalities by top impressions metric can include an ordered list of the top N entities who most affect an expected number of top impressions for the first entity. A top outbound externalities by top impressions metric can include an ordered list of the top N entities whose expected number of top impressions is most affected by the first entity.

An aggregate externality effect is reported based on the aggregating (458), wherein the aggregated externality effect is a measure of an effect of inventory items from the second domain on the inventory item. A report can be provided, for example, to an entity associated with the first domain (e.g., a first entity), an entity associated with the second domain (e.g., a second entity), or to an administrator of a content management system used to perform the auctions. In some implementations, a report can include one or more suggestions to the first entity for adjusting one or more campaigns, e.g., based on the aggregated externality effect of the inventory items from the second domain. For example, a suggestion can be provided to change a bid amount. As another example, a suggestion can be provided to consider whether to continue to bid on particular selection criteria or to withdraw from bidding on the particular selection criteria, such as due to particularly strong competition from the second entity for selection criteria that may not be associated with an important line of business of the first entity.

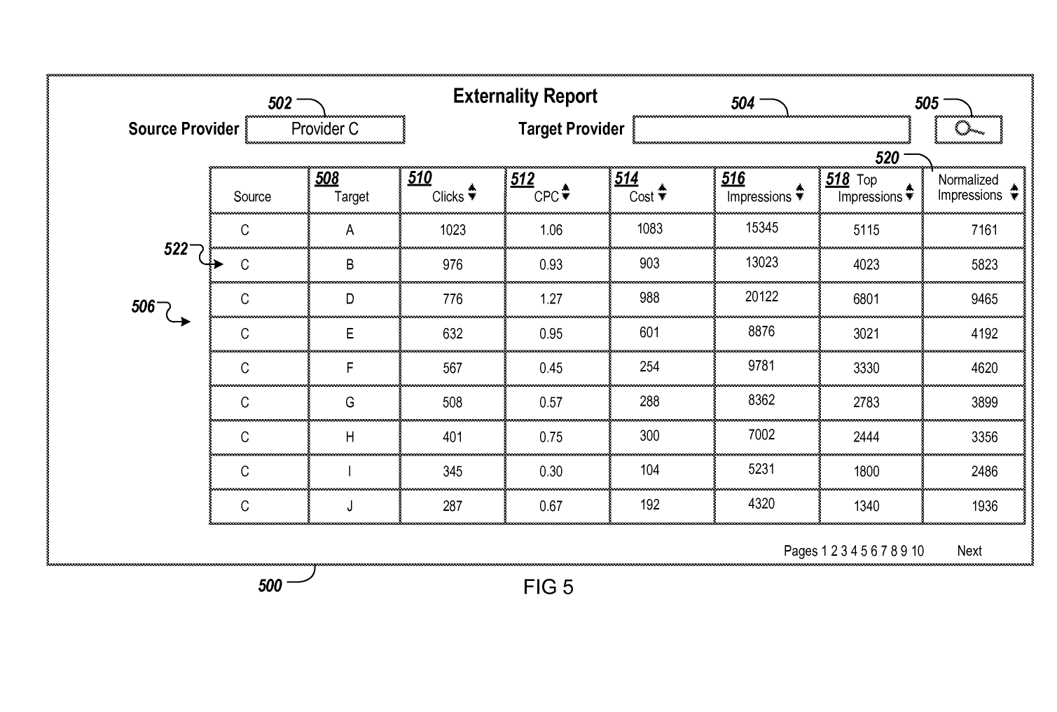

FIG. 5 illustrates an example externality report 500. Report inputs can include a source content provider (e.g., input using a user interface control 502) and a target content provider (e.g., input using a user interface control 504). A source content provider is a content provider for which externality on other content providers is reported. A target content provider is a content provider on which a source content provider is imposing externalities. In some implementations, when the report 500 is presented to an administrator of the content management system, both the user interface controls 502 and 504 are displayed, which can allow the administrator to enter or select any pair of content providers as source and target content providers. In some implementations, when the report 500 is presented to a particular content provider, one or both of the user interface controls 502 and 504 are not displayed. For example, the source content provider or the target content provider can be defaulted to the particular content provider.

As another example, other user interface controls can be presented, which can allow the particular content provider to select one or more particular content items or content campaigns or other content groupings as a source or target input. In some implementations, the report 500 can include user interface controls which enable a user to input one or more dimensions which can be used to filter the report 500. For example, one or more dimensions can be used to filter the report to be based on one or more of auctions occurring during a particular time period, auctions in association with a user located at a particular location or set of locations, auctions associated with particular types of users, or auctions associated with requests from a particular requesting resource. A control 505 can be selected to submit a report request.

The report 500 displays information relating to externality effects that the source content provider imposes on one or more target content. For example, the source content provider is specified in the user interface control 502 as “content provider C”. A target content provider is not specified in the user interface control 504, which can indicate that data is to be reported for all (or a predetermined number of) content providers who are affected by the content provider C. For example, report rows 506 include externality data relating to how content providers A, B, D, E, F, G, H, I, and J are affected by the content provider C, where each target content provider is listed in a column 508. For each listed target content provider, the report 500 includes externality data in columns 510-520 which indicate a change in clicks, cost-per-click (CPC), campaign cost, number of impressions, number of top impressions, and number of normalized impressions, respectively, which are estimated to occur if the source content provider C was not present in auctions in which the content provider B participated. For example, a row 522 indicates that if the content provider C was not present that the content provider B would receive 976 more clicks, pay 0.93 cents more per click, spend an additional $903, and receive 13023 additional impressions, 4023 additional top impressions, and 5823 additional normalized impressions. Other data can be shown on the report 500. For example, the report 500 can include other auction insight information determined from analyzing auctions associated with the source content provider.

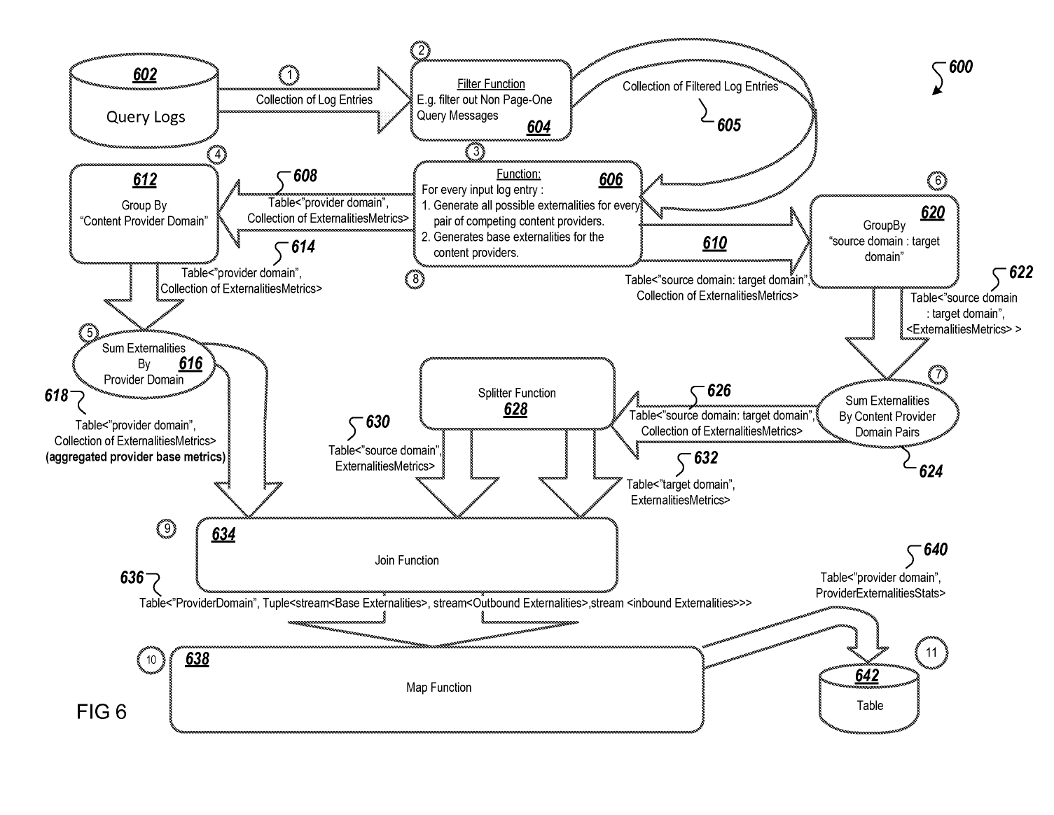

FIG. 6 is a flowchart of an example process 600 for determining an aggregate externality effect. The process 600 can be performed, for example, by the content management system 110 described above with respect to FIG. 1.

A collection of log entries are retrieved from a query logs datastore 602. The query logs datastore 602 can include, for example, log data related to auctions occurring in response to requests for content associated with received search query requests. For each search query request, a log entry can include information related to content items that were selected in response to the request (e.g., a shown impression set) and information related to content items that were considered but not selected in response to the request (e.g., a not-shown impression set).

A filter function 604 is applied to the collection of log entries to produce a collection of filtered log entries 605. For example, in some implementations, the process 600 is performed in response to a request for an externality report, and one or more filter dimensions can be provided in association with the report request. Filter dimensions can include, for example, a time period, a location, a demographic criterion, a requesting source, or other grouping. In some implementations, query log entries associated with query results presented on a page other than a first search result page can be filtered out of the collection of log entries. Other filtering can be performed.

A function 606 is invoked. In some implementations, the function 606 processes the collection of filtered log entries 605 to generate a table 608 of base externalities metrics and a table 610 of simulated externalities metrics. The table 610 can include log entry data associated with a pair of a particular source content provider domain and a particular target content provider domain. To produce the table 608, the function 606 can iterate over each content placement included in the shown impression set of each log entry and the top (e.g., top ten) content placements included in the not-shown impression set of the log entry. For example, content placements can be determined for each content placement included in the shown impressions set and the top not-shown impressions set using an auction simulator. Base metrics can be determined by determining estimates of positioned-based interaction rates, normalized impressions, impressions, top impressions, and cost from the determined placements. The base metrics can be stored in the table 608, keyed, for example, by content provider domain.

To determine the table 610, the auction simulation can be re-performed after removing a content placement associated with the source content provider, to determine externalities on content placements for a set of target content providers. The auction simulator can determine simulated placements for each of the content placements included in the impression set and the top not-shown impression set of a particular log entry. Simulated metrics can be determined by determining estimates of positioned-based interaction rates, normalized impressions, impressions, top impressions, and cost from the determined placements. Externalities can be determined by determining differences between corresponding base and simulated metrics. The determined externalities can be stored in the table 610, keyed, for example, by source content provider domain and target content provider domain.

The entries in the table 608 may include multiple entries with the same key, such as due to one or more content providers competing in multiple auctions. D in the table 608 can be grouped (such as by using a grouping function 612) by content provider to generate grouped base metrics 614. The grouped base metrics 614 can be aggregated (such as by aggregator 616) by provider to generate aggregated provider base metrics 618. The entries in the table 610 may also include multiple entries with the same key, such as due to a same pair of content providers competing in different auctions and/or due to a same query being requested multiple times in a time period (e.g., a day). Data in the table 610 can thereafter be grouped by source domain/target domain pairs to generate grouped externalities metrics 622 (e.g., using a grouping function 620). The grouped externalities metrics 622 can be aggregated by source content provider/target content provider pair, to generate aggregated externalities metrics 626.

The aggregated externalities metrics 626 are split (such as by a splitter function 628) to generate a table 630 which includes externalities imposed by a source provider that is keyed by source provider domain and a table 632 which includes externalities imposed on a target provider that is keyed by target provider domain. The tables 630 and 632 and the aggregated provider base metrics 618 are used to create a table 636 (such as by a join function 634). The table 636 includes tuples of base externalities, source (e.g., outbound) externalities, and target (e.g., inbound) externalities, keyed by provider domain.

The table 636 can be mapped (such as by a map function 638), so as to sum up base metrics for each provider into a base externalities instance, sum up inbound and outbound externalities for each provider, and determine top inbound and top outbound externalities (e.g., in terms of providers) for each provider, in terms, for example, of interactions, conversions, cost, and placement changes. The map function 638 can generate a table 640 which has consolidated provider externality statistics for each provider. The table 640 can be stored in a data store 642, and data can be retrieved from the data store 642, for example, to generate externalities reports.

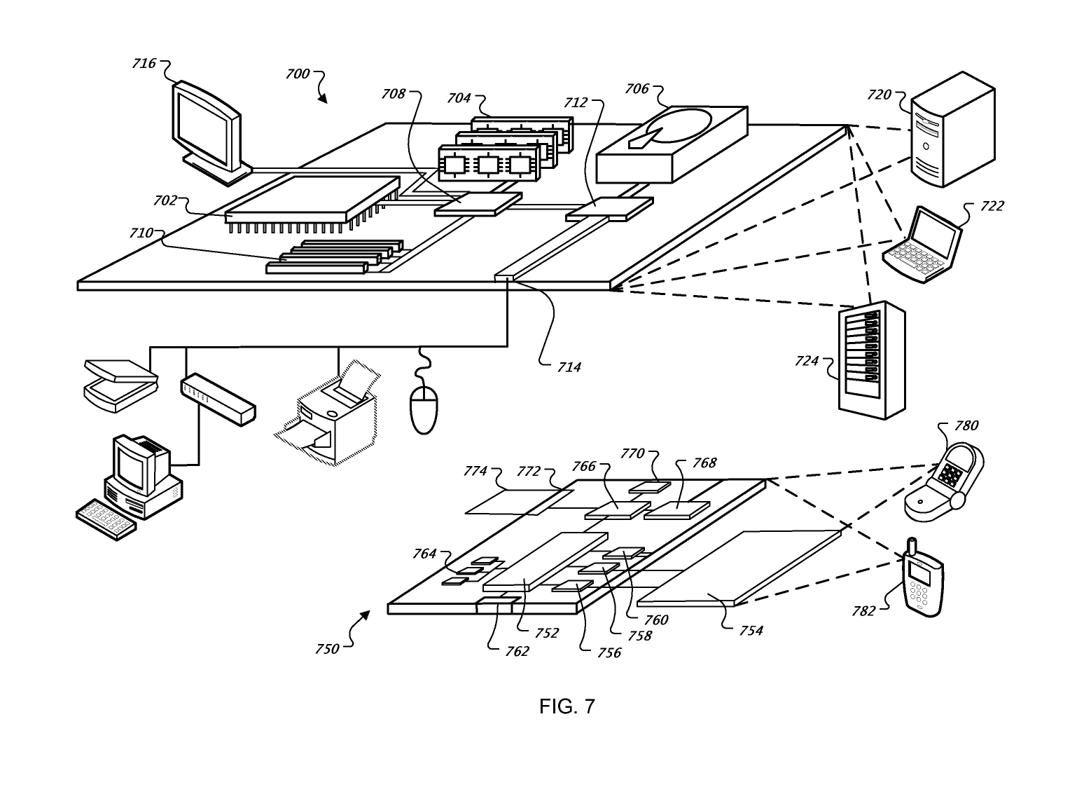

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. The computer-readable medium is not a propagating signal. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communication audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
identifying an auction associated with a content item request, the auction including one or more eligible inventory items for presentation responsive to the content item request and including a first inventory item associated with a first entity;
evaluating results of the auction including determining an externality effect of another eligible inventory item in the auction on the first inventory item; and
reporting the externality effect.

2. The method of claim 1 wherein determining the externality effect includes determining an effect on the first inventory item of removing the another eligible inventory item from the auction.

3. The method of claim 2 wherein determining the externality effect includes simulating the performance of the auction with the another eligible inventory item removed from the auction.

4. The method of claim 2 wherein determining the externality effect includes determining one or more of a change in cost to the first entity, a change in position of the first inventory item on a resource associated with the request, a change in predicted interaction rate for the first inventory item, or a change in a predicted conversion rate for the first inventory item.

5. The method of claim 1 further comprising determining a second externality effect wherein the second externality effect is a measure of an effect of the first inventory item on the another eligible inventory item in the auction and reporting the second externality effect.

6. The method of claim 1 further comprising identifying a plurality of additional auctions in which the first inventory item and the another eligible inventory item participated, evaluating results of the plurality of auctions including determining for each auction an externality effect of the another eligible inventory item in the auction on the first inventory item, aggregating the determined externality effects for each auction, and reporting the aggregate externality effect.

7. The method of claim 5 wherein the plurality of auctions are in a same dimension as the auction and aggregating the externality effect includes aggregating an effect over the dimension.

8. The method of claim 6 wherein the dimension defines a grouping including a grouping defined by a time period, a location, a demographic criterion, a requesting source, or other grouping.

9. The method of claim 1 further comprising receiving the request for content, determining a ranking for the first inventory item and the another eligible inventory item in the auction and enabling presentation of a content item responsive to the request based at least in part on the determined ranking.

10. The method of claim 1 further comprising providing a suggestion to the first entity for adjusting a campaign associated with the first inventory item.

11. The method of claim 1 further comprising determining one or more additional auctions in which the first inventory item competed against either the another inventory item or other inventory items associated with a same domain, determining an externality for each additional auction, aggregating the determined externality data for the additional auctions, and reporting an aggregate externality effect based on the aggregating wherein the aggregated externality effect is a measure of an effect of inventory items from the domain on the first inventory item.

12. A computer program product tangibly embodied in a computer-readable storage device and comprising instructions that, when executed by a processor, cause the processor to:
identify an auction associated with a content item request, the auction including one or more eligible inventory items for presentation responsive to the content item request and including a first inventory item associated with a first entity;
evaluate results of the auction including determining an externality effect of another eligible inventory item in the auction on the first inventory item; and
report the externality effect.

13. The product of claim 12 wherein determining the externality effect includes determining an effect on the first inventory item of removing the another eligible inventory item from the auction.

14. The product of claim 13 wherein determining the externality effect includes simulating the performance of the auction with the another eligible inventory item removed from the auction.

15. The product of claim 13 wherein determining the externality effect includes determining one or more of a change in cost to the first entity, a change in position of the first inventory item on a resource associated with the request, a change in predicted interaction rate for the first inventory item, or a change in a predicted conversion rate for the first inventory item.

16. The product of claim 12 further comprising determining a second externality effect wherein the second externality effect is a measure of an effect of the first inventory item on the another eligible inventory item in the auction and reporting the second externality effect.

17. A system comprising:
a content management system; and
an auction simulator;
wherein the auction simulator is configured to:
identify an auction associated with a content item request received by the content management system, the auction including one or more eligible inventory items for presentation responsive to the content item request and including a first inventory item associated with a first entity; and
wherein the content management system is configured to:
evaluate results of the auction including determining an externality effect of another eligible inventory item in the auction on the first inventory item; and
report the externality effect.

18. The system of claim 17 wherein determining the externality effect includes determining an effect on the first inventory item of removing the another eligible inventory item from the auction.

19. The system of claim 18 wherein determining the externality effect includes simulating the performance of the auction with the another eligible inventory item removed from the auction.

20. The system of claim 18 wherein determining the externality effect includes determining one or more of a change in cost to the first entity, a change in position of the first inventory item on a resource associated with the request, a change in predicted interaction rate for the first inventory item, or a change in a predicted conversion rate for the first inventory item.
